(19) United States
(12) Patent Application Publication
(10) Pub. No.: US 2011/0064422 A1
(43) Pub. Date: Mar. 17, 2011

(54) POLARIZATION SPLITTER, OPTICAL HYBRID AND OPTICAL RECEIVER INCLUDING THE SAME

(75) Inventors: Jong-Hoi Kim, Daejeon (KR); Eun Soo Nam, Daejeon (KR); Yong-Hwan Kwon, Daejeon (KR); Chun Ju Youn, Daejeon (KR); Joong-Seon Choe, Daejeon (KR); Kwang-Seong Choi, Daejeon (KR)

(73) Assignee: ELECTRONICS AND ELECOMMUNICATIONS RESEARCH INSTITUTE, Daejeon (KR)

(21) Appl. No.: 12/765,360

(22) Filed: Apr. 22, 2010

(30) Foreign Application Priority Data
Sep. 17, 2009 (KR) 10-2009-0088127

(51) Int. Cl. H04B 10/06; G02B 6/42

(52) U.S. Cl. 398/214; 385/31

(57) ABSTRACT

Provided is an optical receiver used for an optical communication system, more particularly, a polarization split-phase shift demodulation coherent optical receiver. An optical hybrid includes a first optical splitter, a phase shift waveguide, a second optical splitter, and an optical coupler. The first optical splitter splits a first input optical signal to output first output optical signals. The phase shift waveguide receives the first output optical signals and controls and outputs the first output optical signals such that the first output optical signals have different phases. The second optical splitter splits a second input optical signal to output a plurality of second output optical signals. The optical coupler couples the first output optical signals one-to-one with the second output optical signals, respectively.

### CROSS-REFERENCE TO RELATED APPLICATIONS

This U.S. non-provisional patent application claims priority under 35 U.S.C. §119 of Korean Patent Application No. 10-2009-0088127, filed on Sep. 17, 2009, the entire contents of which are hereby incorporated by reference.

### BACKGROUND OF THE INVENTION

The present invention disclosed herein relates to an optical receiver used for an optical communication system, and more particularly, to a polarization split-phase shift demodulation coherent optical receiver.

Optical communication transmits and receives information using total internal reflection of light through an optical fiber formed of a double glass. Unlike electrical communication, the optical communication has advantages that there is no interference caused by external electromagnetic waves, wiretapping is difficult, and it can process a large amount of information simultaneously.

The optical communication transmits and receives an optical signal through an optical fiber formed of an inner glass (core) having a large refractive index and an outer glass (cladding) having a small refractive index. A transmission terminal converts an electrical signal into an optical signal, and then transmits the converted optical signal via an optical fiber. A reception terminal converts an optical signal into an electrical signal. To convert an electrical signal into an optical signal, a laser diode or a light emitting diode is used. To convert an optical signal into an electrical signal, a photoelectric device such as a photoelectric diode is used.

Recently, as ultrahigh-speed Internet and various multimedia services emerge, a coherent light transmission optical communication system is being studied in order to provide a large capacity of information. Since the coherent light transmission scheme has high spectrum efficiency and high reception sensitivity compared to an Intensity-Modulation Direct-Detection (IMDD) scheme, a transmission capacity may be increased.

Therefore, for commercialization of a coherent optical communication system technology, development of a coherent optical transmitter and a coherent optical receiver that can be easily produced in large quantities and can reduce manufacturing costs is required.

### SUMMARY OF THE INVENTION

The present invention provides an optical receiver that is easily integrated in a single substrate by being formed in the same waveguide layer structure.

Embodiments of the present invention provide optical hybrids including a first optical splitter for splitting a first input optical signal to output a plurality of first output optical signals; a phase shift waveguide for receiving the plurality of first output optical signals and controlling and outputting the plurality of first output optical signals such that the plurality of first output optical signals have different phases; a second optical splitter for splitting a second input optical signal to output a plurality of second output optical signals; and an optical coupler for coupling the plurality of first output optical signals output from the phase shift waveguide one-to-one with the plurality of second output optical signals output from the second optical splitter, respectively.

In other embodiments of the present invention, polarization splitters include: an optical splitter for splitting an optical signal including first and second polarized signals into first and second optical signals; a birefringence waveguide for receiving the first optical signal and outputting a first optical signal where a phase difference between first and second polarized signals of the first optical signal is 180°; a phase shift waveguide for receiving the second optical signal and outputting a second optical signal where phases of first and second polarized signals of the second optical signal are shifted by 90° relative to a phase of the first polarized signal output from the birefringence waveguide; and a multi-mode interference coupler for splitting first and second polarized signals of the optical signal in response to outputs of the phase shift waveguide and the birefringence waveguide.

In still other embodiments of the present invention, optical receivers include: a first polarization splitter for receiving an optical signal including first and second polarized signals and splitting the received optical signal into the first and second polarized signals; a second polarization splitter for receiving a reference signal including first and second reference polarized signals and splitting the received reference signal into the first and second reference polarized signals; a first optical hybrid for coupling the first polarized signal with the first reference polarized signal and outputting a first interference signal; a second optical hybrid for coupling the second polarized signal with the second reference polarized signal, and outputting a second interference signal; and an optical detector for outputting an electrical signal corresponding to the first and second interference signals.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram illustrating an optical receiver according to an embodiment of the present invention;

FIG. 2 is a detailed block diagram illustrating a first polarization splitter illustrated in FIG. 1;

FIG. 3 is a detailed view illustrating a multi-mode interference coupler of FIG. 2; and

FIG. 4 is a detailed block diagram illustrating a first optical hybrid of FIG. 1; and

FIG. 5 is a detailed block diagram illustrating another embodiment of a first optical hybrid of FIG. 1.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Reference numerals are used for preferred embodiments of the present invention, examples of which are provided in the accompanying drawings. In any possible case, like reference numerals are used for description and the drawings to denote like or similar parts.

An optical receiver is used as an example to describe characteristics and functions of the present invention. However, those skilled in the art would understand other advantages and performances of the present invention according to the description set forth herein. Furthermore, detailed description may be modified or changed depending on an aspect and application without departing from the scope, spirit and other purposes of the present invention.

As described above, as an amount of data transmission increases, an effort for increasing a transmission capacity of an optical fiber is made constantly. For this purpose, a Wavelength Division Multiplexing (WDM) optical communication system increases a transmission capacity of a system by increasing the number of channels. In addition, for an alternative, there is a method of increasing the frequency use efficiency by using a modulation method where a channel bandwidth is narrow. In this case, more channels may be transmitted on a given bandwidth by narrowing a channel interval.

However, in the case of a binary signal such as an IMDD type direct intensity modulation signal, it is difficult to transmit a signal of a 1-bit or more in a unit frequency. Therefore, a bandwidth of an optical communication system can be efficiency used by using a multi-phase modulation method such as an M-ary Phase Shift Keying (PSK), Quadrature Phase Shift Keying (QPSK), and Quadrature Amplitude Modulation (QAM) instead of a binary modulation method.

The above-described multi-phase modulation method increases the number of bits transmitted per unit frequency, and is used together with a balanced receiver to provide a high frequency use efficiency and high reception sensitivity compared to an existing Non Return-to-Zero (NRZ) optical communication system.

Recently, as a method for realizing an ultra high-speed large capacity optical communication system, a coherent optical communication system that uses a polarization division multiplexing-based phase modulation is widely studied. In the polarization division multiplexing-based phase modulation, a transmitter splits two polarization components perpendicularly crossing each other, phase-modulates each component, and then couples them to generate an optical signal. A receiver splits a polarization component of an optical signal and detects a phase of each polarization component.

In the polarization division multiplexing-based phase modulation, a coherent optical receiver includes at least one polarization splitter for splitting two polarization components, and at least one optical hybrid for generating a same phase component and a perpendicular phase component of an optical signal. That is, in the polarization division multiplexing-based phase modulation, polarization multiplexing and PSK are simultaneously used.

A plurality of polarization splitters and a plurality of optical hybrids may be separate individual devices, and an optical receiver may be a mechanical combination of these devices. Therefore, mass production of the optical receiver may not be easy and may be high-priced. In addition, since a phase of optical signal that is phase-shifted and transmitted is detected after the signal passes through all optical paths of connections between the individual devices, a phase change may be generated due to an external influence.

Therefore, a polarization division multiplexing-based coherent optical receiver that minimizes a phase change caused by an external influence and is easily produced in large quantities at low costs by integrating individual devices in a single substrate is required. Accordingly, an aspect of the present invention is to provide an optical receiver that is advantageous in an aspect of manufacturing costs and is easily produced in large quantities by providing a structure in which a polarization splitter and an optical hybrid can be integrated in a single substrate.

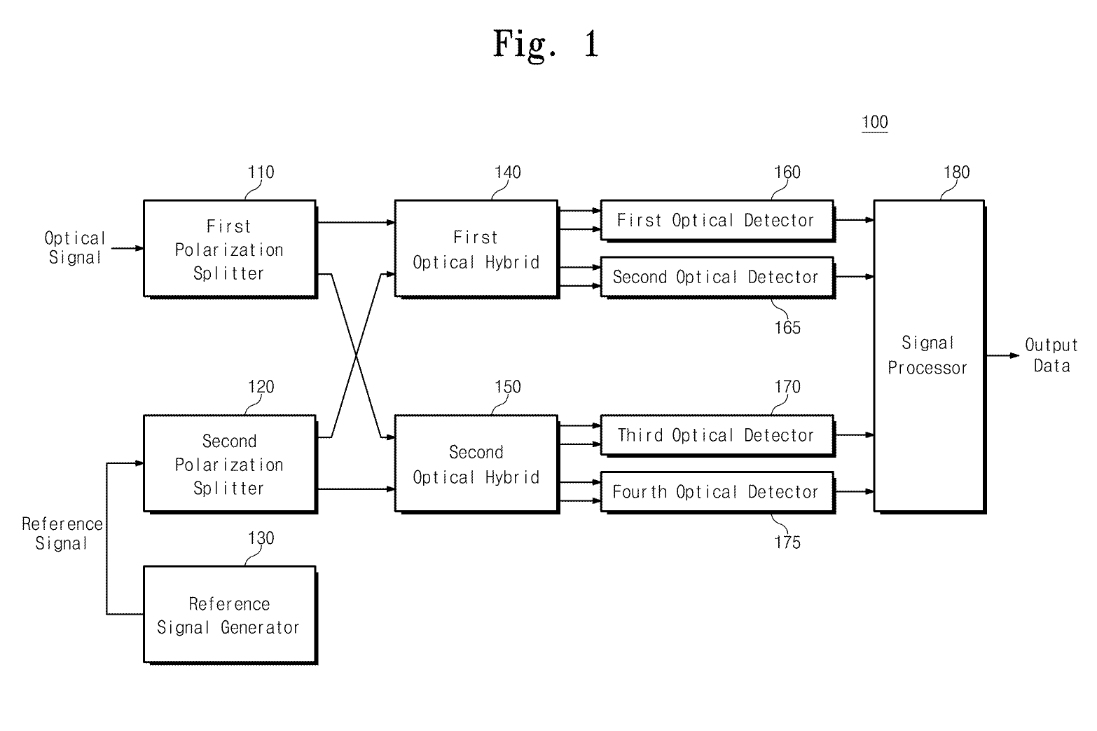

FIG. 1 is a block diagram illustrating an optical receiver according to an embodiment of the present invention. Referring to FIG. 1, the optical receiver 100 includes a first polarization splitter 110, a second polarization splitter 120, a reference signal generator 130, a first optical hybrid 140, a second optical hybrid 150, first through fourth optical detectors 160 through 175, and a signal processor 180.

The first polarization splitter 110 receives an optical signal from an optical transmitter. An optical signal denotes a signal polarization-multiplexed and phase-modulated by the optical transmitter. Polarized light denotes light where a direction of an electric field is constant on an arbitrary plane perpendicular to a progression direction. Since a transverse wave such as light where a physical quantity vibrates vertically with respect to a progression direction can have two vibration directions, the two vibration directions may be separately treated.

In detail, assuming that a progression direction is a z-direction, a vibration direction may be split into two directions of an x-direction and a y-direction, which are called an x-polarization state and a y-polarization state, respectively. Since a wave vibrating in an arbitrary direction of an x-y plane may be though as a synthesis of polarization states of two directions, only a polarization component of one direction can be separated.

Referring to FIG. 1 again, a received optical signal is split into a first polarized signal and a second polarized signal by the first polarization splitter 110. The first polarized signal and the second polarized signal are transferred to the first optical hybrid 140 and the second optical hybrid 150, respectively. In an embodiment of the present invention, the first polarized signal is transferred to the first optical hybrid 140, and the second polarized signal is transferred to the second optical hybrid 150.

The second polarization splitter 120 receives a reference signal from the reference signal generator 130. A reference signal includes reference phase information for phase-demodulating an optical signal. A reference signal is split into a first reference polarized signal and a second reference polarized signal by the second polarization splitter 120. Split reference polarized signals are transferred to the first optical hybrid 140 and the second optical hybrid 150, respectively. In an embodiment of the present invention, the first reference polarized signal is transferred to the first optical hybrid 140, and the second reference polarized signal is transferred to the second optical hybrid 150.

The first optical hybrid 140 receives the first polarized signal from the first polarization splitter 110, and receives the first reference polarized signal from the second polarization splitter 120. The first optical hybrid 140 detects a phase of the first polarized signal using the first reference polarized signal. An output of the first optical hybrid 140 is transferred to the first optical detector 160 and the second optical detector 165.

The second optical hybrid 150 receives the second polarized signal from the first polarization splitter 110, and receives the second reference polarized signal from the second polarization splitter 120. The second optical hybrid 150 detects a phase of the second polarized signal using the second reference polarized signal. An output of the second optical hybrid 150 is transferred to the third optical detector 170 and the fourth optical detector 175.

The first through fourth optical detectors 160 through 175 receive outputs from the first optical hybrid 140 or the second optical hybrid 150. The first through fourth optical detectors 160 through 175 generate electrical signals (for example, a current or a voltage) corresponding to light intensities. Electrical signals generated by the first through fourth optical detectors 160 through 175 are transferred to the signal processor 180.

The signal processor 180 reads data included in an optical signal based on a received electrical signal. Read data is output as output data.

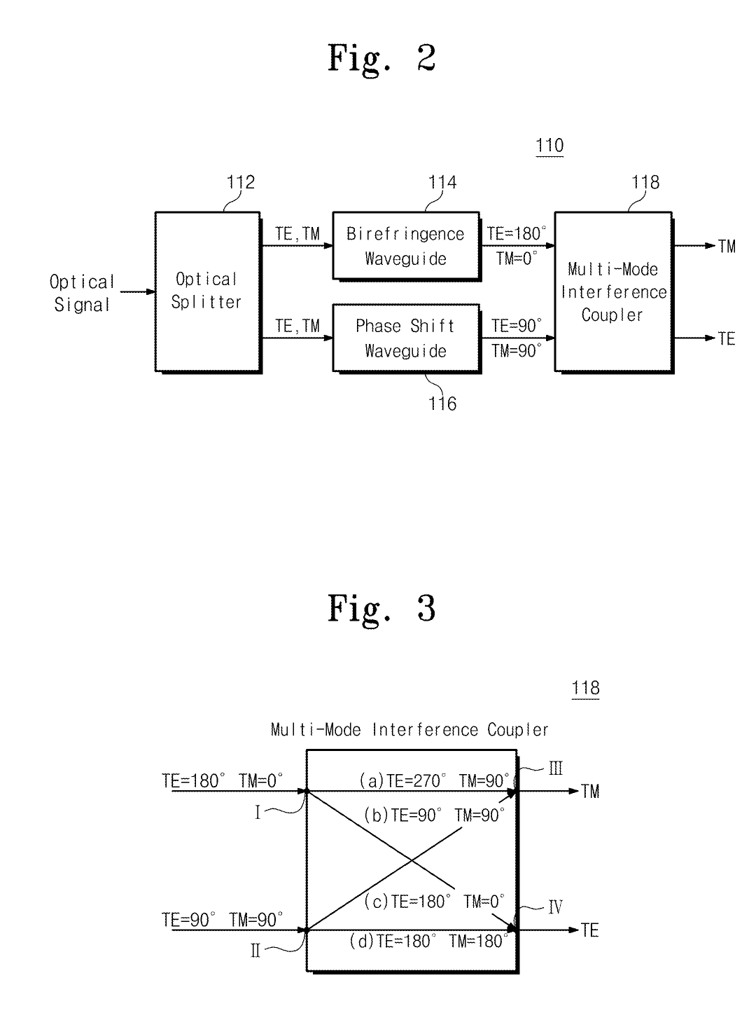

FIG. 2 is a detailed block diagram illustrating a first polarization splitter illustrated in FIG. 1. Since the structure of the first polarization splitter 110 is the same as that of the second polarization splitter 120, only the structure of the first polarization splitter 110 is described for convenience in description. Referring to FIG. 2, the first polarization splitter 110 includes an optical splitter 112, a birefringence waveguide 114, a phase shift waveguide 116, and a multi-mode interference coupler 118.

The optical splitter 112 splits and outputs an optical signal received from an optical transmitter. An optical signal is a signal polarization-multiplexed and phase-modulated by the optical transmitter. An optical signal includes a first polarized signal TE and a second polarized signal TM. Optical signals split by the optical splitter 112 are transferred to the birefringence waveguide 114 and the phase shift waveguide 116, respectively.

The birefringence waveguide 114 generates a phase difference of 180° between the first polarized signal TE and the second polarized signal TM. For example, the birefringence waveguide 114 can allow the first polarized signal TE to have a phase of 180° and the second polarized signal TM to have a phase of 0°. The phase shift waveguide 116 shifts phases such that the phases of the first polarized signal TE and the second polarized signal TM become 90°.

Though outputs of the birefringence waveguide 114 and the phase shift waveguide 116 have been described to have specific phases according to an embodiment of the present invention, it is noted that the phases are relative. That is, what is important in the present invention is that the first polarized signal TE output from the birefringence waveguide 114 has a 90° greater phase than that of the first polarized signal TE of the phase shift waveguide 116, and the second polarized signal TM output from the birefringence waveguide 114 has a 90° smaller phase than that of the first polarized signal TE of the phase shift waveguide 116.

For example, in the case where the phase shift waveguide 116 shifts phases such that the first polarized signal TE and the second polarized signal TM have the phases of 0°, the birefringence waveguide 114 shifts the phases such that the first polarized signal TE has a phase of 90° and the second polarized signal TM has a phase of −90°.

Therefore, it would be obvious to those skilled in the art that various embodiments may be easily derived depending on a phase shift value at the phase shift waveguide 116.

The multi-mode interference coupler 118 splits the first polarized signal TE and the second polarized signal TM in response to an output from the birefringence waveguide 114 and the phase shift waveguide 116. The structure of the multi-mode interference coupler 118 is described in more detail with reference to FIG. 3.

FIG. 3 is a detailed view illustrating a multi-mode interference coupler of FIG. 2. The multi-mode interference coupler 118 is used to split the first polarized signal TE and the second polarized signal TM by allowing signals where the first polarized signal TE and the second polarized signal TM are mixed to interfere with each other.

Referring to FIG. 3, the multi-mode coupler 118 includes two input terminals I and II, and two output terminals III and IV. The multi-mode interference coupler receives a first input signal (TE=180°, TM=0°) from the birefringence waveguide 114. The first input signal includes the first polarized signal TE and the second polarized signal TM. The first input signal is transferred to the first output terminal III and the second output terminal IV. While the first input signal is transferred to the first output terminal III, a phase increases by 90°. In contrast, while the first input signal is transferred to the second output terminal IV, a phase change does not occur.

Referring to FIG. 3, the first input signal (TE=180°, TM=0°) is increased in its phase by 90° and transferred to the first output terminal III (a). In addition, the first input signal (TE=180°, TM=0°) is transferred to the second output terminal IV without a phase change (b).

The multi-mode coupler 118 receives a second input signal (TE=90°, TM=90°) from the phase shift waveguide 116. The second input signal (TE=90°, TM=90°) includes a first polarized signal TE and a second polarized signal TM. While the second input signal is transferred to the first output terminal III, a phase change does not occur. In contrast, while the second input signal is transferred to the second output terminal IV, a phase increases by 90°.

Referring to FIG. 3 again, the second input signal (TE=90°, TM=90°) is increased in its phase by 90° and transferred to the second output terminal IV (d). In addition, the second input signal (TE=90°, TM=90°) is transferred to the first output terminal III without a phase change (c).

The first output terminal III receives a signal (a) from the first input terminal i, and receives a signal (b) from the second input terminal II. Since a first polarized signal TE of the signal (a) and a first polarized signal TE of the signal (b) have a phase difference of 180°, they are cancelled. In contrast, since a second polarized signal TM of the signal (a) and a second polarized signal TE of the signal (b) have the same phase, they overlap each other. Consequently, only the second polarized signal TM is output via the first output terminal III.

The second output terminal IV receives a signal (c) from the first input terminal i, and receives a signal (d) from the second input terminal II. Since a second polarized signal TM of the signal (c) and a second polarized signal TM of the signal (d) have a phase difference of 180°, they are cancelled. In contrast, since a first polarized signal TE of the signal (c) and a first polarized signal TE of the signal (d) have the same phase, they overlap each other. Consequently, only the first polarized signal TE is output via the second output terminal IV.

Through the above-described method, a first polarized signal and a second polarized signal of an optical signal can be separated by the first polarization splitter 110. In the same way, a first reference polarized signal and a second reference polarized signal of a reference signal can be separated by the second polarization splitter 120.

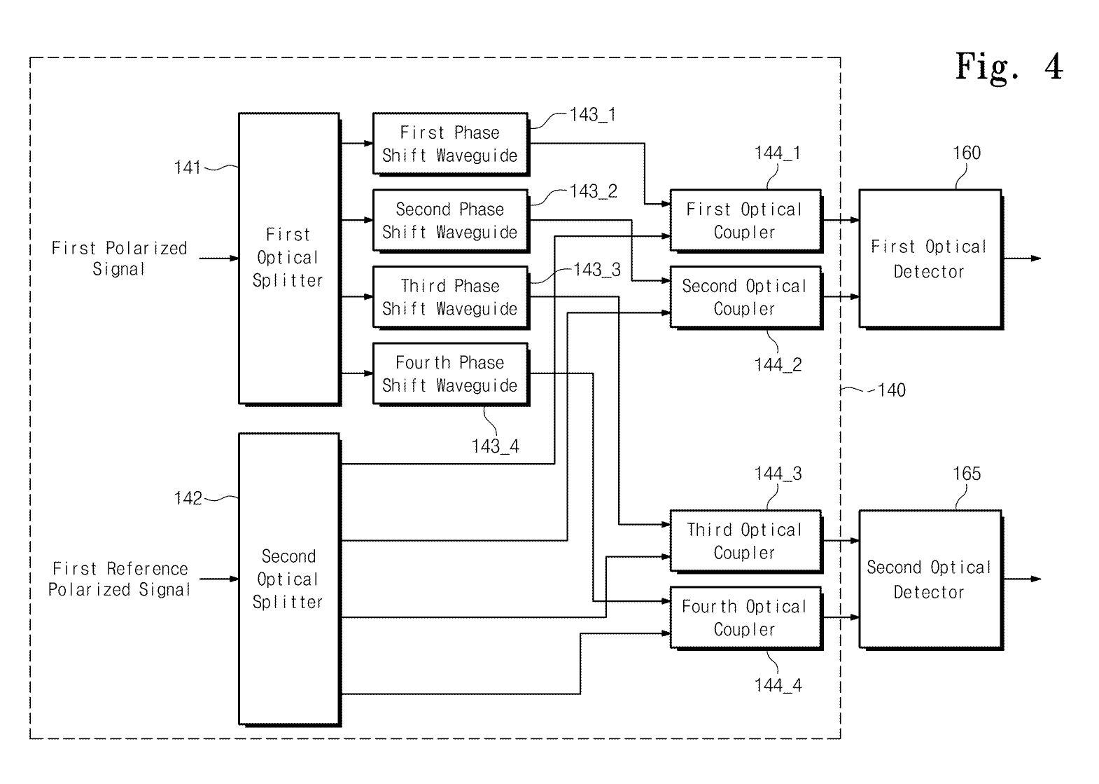

FIG. 4 is a detailed block diagram illustrating a first optical hybrid of FIG. 1. Since the structure of the first optical hybrid 140 is the same as that of the second optical hybrid 150, only the structure of the first optical hybrid 140 is described for conciseness in description.

Referring to FIG. 4, the first optical hybrid 140 includes a first optical splitter 141, a second optical splitter 142, first through fourth phase shift waveguides 143_1 through 143_4, and first to fourth optical couplers 144_1 through 144_4. An output of the first optical hybrid 140 is applied to the first optical detector 160 and the second optical detector 165.

The first optical splitter 141 splits a first polarized signal into four signals. Split first polarized signals are applied to the first through fourth phase shift waveguides 143_1 through 143_4, which change phases of the first polarized signals such that the first polarized signals have phase differences of 90°, respectively.

For example, the first phase shift waveguide 143_1 does not change a phase of the first polarized signal. The second phase shift waveguide 143_2 changes a phase of the first polarized signal by 180°. The third phase shift waveguide 143_3 changes a phase of the first polarized signal by 90°. The fourth phase shift waveguide 143_4 changes a phase of the first polarized signal by 270°.

The second optical splitter 142 splits a first reference polarized signal into four signals. Split first reference polarized signals are applied to the first through fourth optical couplers 144_1 through 144_4. The first optical coupler 144_1 receives the first polarized signal from the first phase shift waveguide 143_1, and receives the first reference polarized signal from the second optical splitter 142. The first polarized signal has the same phase as that of the first reference polarized signal. Therefore, an output of the first optical coupler 144_1 corresponds to the same phase component, and is applied to the first optical detector 160.

The second optical coupler 144_2 receives a first polarized signal whose phase has been delayed by 180° by the second phase shift waveguide 143_2, and a first reference polarized signal from the second optical splitter 142. A phase of the first polarized signal is 180° greater than that of the first reference polarized signal. Therefore, an output of the second optical coupler 144_2 corresponds to a component having a phase difference of 180° relative to the same phase component, and is applied to the first optical detector 160.

The third optical coupler 144_3 receives a first polarized signal whose phase has been delayed by 90° by the third phase shift waveguide 143_3, and a first reference polarized signal from the second optical splitter 142. A phase of the first polarized signal is 90° greater than that of the first reference polarized signal. Therefore, an output of the third optical coupler 144_3 corresponds to an orthogonal phase component, and is applied to the second optical detector 165.

The fourth optical coupler 144_4 receives a first polarized signal whose phase has been delayed by 270° by the fourth phase shift waveguide 143_4, and a first reference polarized signal from the second optical splitter 142. A phase of the first polarized signal is 270° greater than that of the first reference polarized signal. Therefore, an output of the fourth optical coupler 144_4 corresponds to a component having a phase difference of 180° relative to an orthogonal phase component, and is applied to the second optical detector 165.

Consequently, four interference signals where phase differences between the first polarized signal and the first reference polarized signal gradually increase by 90° are generated and transferred to the first optical detector 160 and the second optical detector 165.

The first optical detector 160 receives an interference signal from the first optical coupler 144_1 and an interference signal from the second optical coupler 144_2. The first optical detector 160 outputs an electrical signal corresponding to a magnitude difference between a signal from the first optical coupler 144_1 and a signal from the second optical coupler 144_2.

The second optical detector 165 receives an interference signal from the third optical coupler 144_3 and an interference signal from the fourth optical coupler 144_4. The second optical detector outputs an electrical signal corresponding to a magnitude difference between a signal from the third optical coupler 144_3 and a signal from the fourth optical coupler 144_4.

Referring to FIG. 2 again, an electrical signal generated by the first optical detector 160 is transferred to the signal processor 180, and an electrical signal generated by the second optical detector 165 is transferred to the signal processor 180.

The signal processor 180 receives an electrical signal output from the first optical detector 160, and receives an electrical signal output from the second optical detector 165 to detect a phase of the first polarized signal.

In brief, an optical hybrid according to an embodiment of the present invention receives a first polarized signal and a first reference polarized signal, and outputs an interference signal. An optical detector outputs an electrical signal corresponding to an interference signal. A signal processor detects data included in a first polarized signal in response to an electrical signal.

In addition, input paths of a first polarized signal and a first reference polarized signal may be exchanged with each other. That is, the first polarized signal may be input to the second optical splitter, and the first reference polarized signal may be input to the first optical splitter because the first through fourth phase shift waveguides merely generate a phase difference between the first polarized signal and the first reference polarized signal.

Though the constructions of the first optical hybrid 140, the first optical detector 160, and the second optical detector 165 have been described with reference to FIG. 4, the second optical hybrid 150, the third optical detector 170, and the fourth optical detector 175 operate in a similar way. Therefore, detailed description thereof is omitted.

In an embodiment of the present invention, the first through fourth phase shift waveguides are used in order to shift a phase of a first polarized signal. The first through fourth phase shift waveguides are formed of the same waveguide layer structure. Therefore, an optical receiver according to an embodiment of the present invention can be easily integrated in a single substrate, and is advantageous in aspects of miniaturization and mass production.

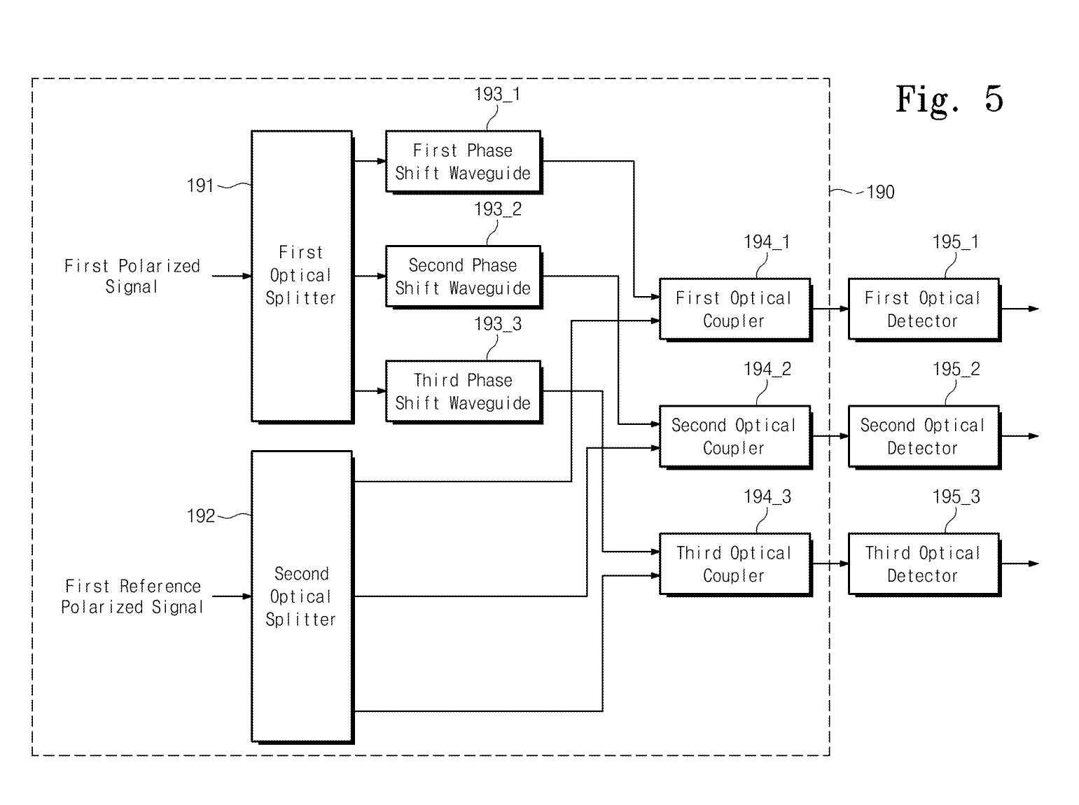

FIG. 5 is a detailed block diagram illustrating another embodiment of a first optical hybrid of FIG. 1. Referring to FIG. 5, the first optical hybrid 190 includes a first optical splitter 191, a second optical splitter 192, first through third phase shift waveguides 193_1 through 193_3, and first through third optical couplers 194_1 through 194_3. An output of the first optical hybrid 190 is applied to first through third optical detectors 195_1 through 195_3.

The first optical splitter 191 splits a first polarized signal into three signals. Split first polarized signals are applied to the first through third phase shift waveguides 193_1 through 193_3, respectively. The first through third phase shift waveguides 193_1 through 193_3 change phases of the first polarized signals such that the phases of the first polarized signals have phase differences of 120°, respectively.

For example, the first phase shift waveguide 193_1 does not change a phase of a first polarized signal. The second phase shift waveguide 193_2 changes a phase of a first polarized signal by 120°. The third phase shift waveguide 193_3 changes a phase of a first polarized signal by 240°.

The second optical splitter 192 splits a first reference polarized signal into three signals. Split first reference polarized signals are applied to the first through third optical couplers 194_1 through 194_3, respectively. The first optical coupler 194_1 receives a first polarized signal from the first phase shift waveguide 193_1, and receives a first reference polarized signal from the second optical splitter 192. The first polarized signal has the same phase as that of the first reference polarized signal. Therefore, an output of the first optical coupler 194_1 corresponds to the same phase component, and is applied to the first optical detector 195_1.

The second optical coupler 194_2 receives a first polarized signal whose phase has been delayed by 120° by the second phase shift waveguide 193_2, and a first reference polarized signal from the second optical splitter 192. A phase of the first polarized signal is 120° greater than that of the first reference polarized signal. Therefore, an output of the second optical coupler 194_2 corresponds to a component having a phase difference of 120° relative to I0, which is the same phase component, and is applied to the second optical detector 195_2.

The third optical coupler 194_3 receives a first polarized signal whose phase has been delayed by 240° by the third phase shift waveguide 193_3, and a first reference polarized signal from the second optical splitter 192. A phase of the first polarized signal is 240° greater than that of the first reference polarized signal. Therefore, an output of the third optical coupler 194_3 corresponds to a component having a phase difference of 240° relative to I0, which is the same phase component, and is applied to the third optical detector 195_3.

Consequently, three interference signals where phase differences between the first polarized signal and the first reference polarized signal gradually increase by 120° are generated and transferred to the first through third optical detectors 195_1 through 195_3.

The first optical detector 195_1 receives an interference signal from the first optical coupler 194_1. The first optical detector 195_1 outputs an electrical signal corresponding to an interference signal from the first optical coupler 194_1. Though not shown, an electrical signal generated by the first optical detector 195_1 is transferred to the signal processor 180.

The second optical detector 195_2 receives an interference signal from the second optical coupler 194_2. The second optical detector 195_2 outputs an electrical signal corresponding to an interference signal from the second optical coupler 194_2. Though not shown, an electrical signal generated by the second optical detector 195_2 is transferred to the signal processor 180.

The third optical detector 195_3 receives an interference signal from the third optical coupler 194_3. The third optical detector 195_3 outputs an electrical signal corresponding to an interference signal from the third optical coupler 194_3. Though not shown, an electrical signal generated by the third optical detector 195_3 is transferred to the signal processor 180.

The signal processor 180 receives an electrical signal from the first optical detector 195_1, receives an electrical signal from the second optical detector 195_2, and receives an electrical signal from the third optical detector 195_3. The signal processor 180 can detect a phase wt of the first polarized signal using the three signals.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical hybrid comprising:
a first optical splitter for splitting a first input optical signal to output a plurality of first output optical signals;
a phase shift waveguide for receiving the plurality of first output optical signals and controlling and outputting the plurality of first output optical signals such that the plurality of first output optical signals have different phases;
a second optical splitter for splitting a second input optical signal to output a plurality of second output optical signals; and
an optical coupler for coupling the plurality of first output optical signals output from the phase shift waveguide one-to-one with the plurality of second output optical signals output from the second optical splitter, respectively.

2. The optical hybrid of claim 1, wherein the first optical splitter splits the first input optical signal into four first output optical signals.

3. The optical hybrid of claim 2, wherein the phase shift waveguide comprises first through fourth phase shift waveguides for receiving the four first output optical signals, respectively, and
the first through fourth phase shift waveguides control and output the four first output optical signals such that phases of the four first output optical signals have an interval of 90°.

4. The optical hybrid of claim 3, wherein the optical coupler comprises first through fourth optical couplers corresponding to the first through fourth phase shift waveguides, respectively, and
the first through fourth optical couplers couple the four first output optical signals output from the first through fourth phase shift waveguides one-to-one with the plurality of second output optical signals output from the second optical splitter, respectively.

5. The optical hybrid of claim 1, wherein the first optical splitter splits the first input optical signal into three first output optical signals.

6. The optical hybrid of claim 5, wherein the phase shift waveguide comprises first through third phase shift waveguides for receiving the three first output optical signals output from the first optical splitter, respectively, and
the first through third phase shift waveguides control and output the three first output optical signals such that phases of the four first output optical signals have an interval of 120°.

7. The optical hybrid of claim 6, wherein the optical coupler comprises first through third optical couplers corresponding to the first through third phase shift waveguides, respectively, and
the first through third optical couplers couple the three first output optical signals output from the first through third phase shift waveguides one-to-one with the plurality of second output optical signals output from the second optical splitter.

8. A polarization splitter comprising:
an optical splitter for splitting an optical signal comprising first and second polarized signals into first and second optical signals;
a birefringence waveguide for receiving the first optical signal and outputting a first optical signal where a phase difference between first and second polarized signals of the first optical signal is 180°;
a phase shift waveguide for receiving the second optical signal and outputting a second optical signal where phases of first and second polarized signals of the second optical signal are shifted by 90° relative to a phase of the first polarized signal output from the birefringence waveguide; and
a multi-mode interference coupler for splitting first and second polarized signals of the optical signal in response to outputs of the phase shift waveguide and the birefringence waveguide.

9. An optical receiver comprising:
a first polarization splitter for receiving an optical signal comprising first and second polarized signals and splitting the received optical signal into the first and second polarized signals;
a second polarization splitter for receiving a reference signal comprising first and second reference polarized signals and splitting the received reference signal into the first and second reference polarized signals;
a first optical hybrid for coupling the first polarized signal with the first reference polarized signal and outputting a first interference signal;
a second optical hybrid for coupling the second polarized signal with the second reference polarized signal, and outputting a second interference signal; and
an optical detector for outputting an electrical signal corresponding to the first and second interference signals.

10. The optical receiver of claim 9, wherein the optical detector comprises:
a first optical detector for outputting an electrical signal corresponding to the first interference signal; and
a second optical detector for outputting an electrical signal corresponding to the second interference signal.

11. The optical receiver of claim 9, further comprising a signal processor for detecting data of the optical signal in response to an electrical signal from the optical detector.
